(19) United States
(12) Patent Application Publication
(10) Pub. No.: US 2026/0317496 A1
(43) Pub. Date: Oct. 15, 2026

(54) MICROEXPANDED POLYPROPYLENE MATERIAL AND PREPARATION METHOD AND USE THEREOF

(71) Applicant: KINGFA SCI. & TECH. CO., LTD., Guangzhou, Guangdong (CN)

(72) Inventors: Fei Yu, Guangzhou, Guangdong (CN); Pingxu Chen, Guangzhou, Guangdong (CN); Nanbiao Ye, Guangzhou, Guangdong (CN); Guofeng Wu, Guangzhou, Guangdong (CN)

(21) Appl. No.: 19/117,114

(22) PCT Filed: Sep. 6, 2023
(86) PCT No.: PCT/CN2023/117137

§ 371 Date: Mar. 31, 2025

(30) Foreign Application Priority Data
Sep. 30, 2022 (CN) 202211212788.3

(51) Int. Cl. C08J 9/16; C08K 3/26; C08K 3/34; C08K 5/098; C08K 5/13; C08K 7/04

(52) U.S. Cl. CPC C08J 9/16; C08K 3/26; C08K 3/346; C08K 5/098; C08K 5/13; C08K 7/04; C08J 2201/03; C08J 2323/12; C08J 2423/20; C08J 2451/06; C08K 2003/265

(57) ABSTRACT

Provided are a microexpanded polypropylene material and a preparation method and use thereof. The micro-EPP material includes the following components: polypropylene, poly(1-butene)-grafted sodium maleate, an ethylene-octene random copolymer, a filler, a lubricant, and an antioxidant. The present disclosure adopts a combination of polypropylene and an ethylene-octene random copolymer that have proper melt flow indexes to ensure the smooth foaming of materials. On this basis, poly(1-butene)-grafted sodium maleate is added. The special low melting point and polar grafting modification of poly(1-butene)-grafted sodium maleate can significantly improve the interfacial bonding between a filler and polypropylene, which is conducive to foam molding.

### TECHNICAL FIELD

The present disclosure relates to the field of polypropylene (PP) materials, and in particular relates to a microexpanded polypropylene (micro-EPP) material and a preparation method and use thereof.

### BACKGROUND

PP, as a crystalline polymer with a regular structure, is often a white granular or powdery material. PP is an odorless, non-toxic, and lightweight thermoplastic resin. PP has advantages such as easy processing and excellent impact strength, flexibility, electrical insulation, and chemical resistance. As a result, PP is extensively used in automotive industry, household appliances, electronics, packaging, building materials, furniture, etc.

With the lightweighting trend in industries such as automotives, foaming has emerged as an important way to achieve the weight reduction. The microcellular foaming of PP has gained widespread popularity, and has been extensively studied for both interior and exterior parts, including door panels, interior door handles, seat track guard plates, etc. Expanded polypropylene (EPP) is a semi-crystalline polymer/gas composite with excellent properties. Due to unique and superior properties, EPP has become the fastest-growing novel eco-friendly material for compression resistance, cushioning, and thermal insulation. EPP products exhibit a range of exceptional properties, including outstanding shock resistance and energy absorption, high recovery rate after deformation, and excellent heat resistance, chemical resistance, oil resistance, and thermal insulation. EPP also has a small mass, which can significantly reduce the overall mass of an item. Moreover, EPP is an eco-friendly material prone to β-degradation. PP foam can be easily recycled, and is more environmentally friendly than other foam materials. Therefore, PP foam is referred to as “green” foam. Due to the prominent properties exhibited by EPP, EPP has emerged as a novel foam material with a high application value and market potential following expanded polystyrene (EPS) and expanded polyurethane (EPU) materials. However, the existing EPP materials suffer from drawbacks, such as orange peel-like appearance, poor uniformity of foam cells, and easy foam cell merging or rupturing.

### SUMMARY

In view of this, an objective of the present disclosure is to overcome the deficiencies of the prior art and provide a micro-EPP material and a preparation method and use thereof. The micro-EPP material is subject to extrusion foaming after the addition of a foaming agent, resulting in a product with excellent appearance, dense and uniform foam cells, a closed-cell ratio of 92% or more, and a high proportion of reduced weight after foaming.

In order to achieve the above objective, the present disclosure adopts the following technical solutions: A micro-EPP material is provided, including the following components in parts by weight: 45 parts to 96 parts of PP, 1 part to 5 parts of poly(1-butene)-grafted sodium maleate, 2 parts to 10 parts of an ethylene-octene random copolymer, 3 parts to 40 parts of a filler, 0.1 part to 0.4 part of a lubricant, and 0.1 part to 0.4 part of an antioxidant.

The PP has a melt flow index of 0.5 to 3 g/10 min under the test condition of 230° C. and 2.16 kg, which is determined in accordance with the test standard ISO 1133-1/2:2012. If the melt flow index of PP is too low, a melt of PP will have a too-high strength, resulting in a poor foaming effect. If the melt flow index of PP is too high, a melt of PP will have a too-low strength, resulting in defects such as foam cell rupturing or merging.

The ethylene-octene random copolymer has a melt flow index of 5 to 13 g/10 min under the test condition of 190° C. and 2.16 kg, which is determined in accordance with the test standard ISO 1133-1/2:2012. The octene in the ethylene-octene random copolymer has a large molecular weight and exhibits a prominent entanglement effect with PP, which is conducive to foaming without cell rupturing caused by insufficient ductility. If the melt flow index of the ethylene-octene random copolymer is too high, there will be cell merging during foaming. If the melt flow index of the ethylene-octene random copolymer is too low, there will be a poor foaming effect.

Preferably, the micro-EPP material includes the following components in parts by weight: 53 parts to 62 parts of the PP, 2 parts to 3 parts of the poly(1-butene)-grafted sodium maleate, 5 parts to 7 parts of the ethylene-octene random copolymer, 10 parts to 30 parts of the filler, 0.1 part to 0.4 part of the lubricant, and 0.1 part to 0.4 part of the antioxidant.

Preferably, the filler is at least one selected from the group consisting of a talc powder, calcium carbonate, and a basic magnesium sulfate whisker.

Preferably, the lubricant is a stearate salt.

Preferably, the antioxidant is a hindered phenol and/or a phosphite ester.

The poly(1-butene)-grafted sodium maleate adopted in the present disclosure has a melting point of 104° C., which is much lower than a melting point of the ordinary PP-grafted maleic anhydride (melting point: 165° C.). The special low melting point and polar grafting modification of the poly(1-butene)-grafted sodium maleate can significantly improve the interfacial bonding between the filler and the PP and solve the problems of non-uniform foam cells and cell rupturing, which is conducive to foam molding.

Preferably, the poly(1-butene)-grafted sodium maleate is prepared by the following process: thoroughly mixing poly(1-butene), sodium maleate, and an antioxidant to produce a mixture; dissolving an initiator, α-methylstyrene (AMS), and 1-octene in acetone to produce a mixed solution; thoroughly mixing the mixed solution with the mixture, and after the acetone is volatilized, conducting melt-extrusion for a grafting reaction to produce the poly(1-butene)-grafted sodium maleate. A grafting ratio of the poly(1-butene)-grafted sodium maleate is 0.8% to 1.5%.

Preferably, the initiator is di-tert-butyl peroxide (DTBP).

Preferably, the antioxidant is a hindered phenol and/or phosphite ester antioxidant.

Preferably, the poly(1-butene)-grafted sodium maleate is prepared from the following components in parts by weight: 100 parts of the poly(1-butene), 1.5 parts to 4.5 parts of the sodium maleate, 0.2 part to 0.4 part of the antioxidant, 0.2 part to 0.4 part of the initiator, 2 parts to 3 parts of the AMS, and 1 part to 1.5 parts of the 1-octene.

Preferably, the melt-extrusion is conducted with a twin-screw extruder at 135° C. to 150° C.

Preferably, the poly(1-butene)-grafted sodium maleate is purified as follows: dissolving the poly(1-butene)-grafted sodium maleate in xylene, conducting precipitation with acetone to produce a precipitate, and washing and drying the precipitate to produce a first purification product; and repeating the above purification process to produce purified poly(1-butene)-grafted sodium maleate.

A preparation method of the micro-EPP material is provided, including the following steps: mixing the components thoroughly, and conducting melt-extrusion granulation; and adding a foaming agent, and conducting extrusion foaming.

Preferably, the melt-extrusion granulation is conducted with a 75D co-rotating twin-screw extruder, and temperatures from a feeding section to a head are sequentially as follows: 170° C., 200° C., 200° C., 210° C., 210° C., 205° C., 205° C., 205° C., 200° C., and 200° C.

Preferably, the foaming agent is added at an amount of 1% to 3% by weight of the micro-EPP material.

A use of the micro-EPP material in preparation of a compression-resistant, cushioning, and heat-insulating material is provided, such as a side guard plate for a car seat and a spare tyre cover for a car trunk.

Compared with the prior art, the present disclosure has the following beneficial effects:

The present disclosure adopts a combination of PP and an ethylene-octene random copolymer that have proper melt flow indexes, which can ensure the smooth foaming of materials. On this basis, poly(1-butene)-grafted sodium maleate is added. The special low melting point and polar grafting modification of poly(1-butene)-grafted sodium maleate can significantly improve the interfacial bonding between a filler and PP, which is conducive to foam molding. The micro-EPP material is subject to extrusion foaming after the addition of a foaming agent, resulting in a product with excellent appearance, dense and uniform foam cells at a grade 1, a closed-cell ratio of 92.3% to 94.3%, a reduced weight proportion of 22.7% to 27.2%, and a density of 0.661 g/cm³ to 0.928 g/cm³ after foaming. The preparation method of the micro-EPP material in the present disclosure involves a simple process and is suitable for mass production.

### DETAILED DESCRIPTION

In order to well illustrate the objective, technical solutions, and advantages of the present disclosure, the present disclosure will be further described below in conjunction with specific examples.

In the examples, unless otherwise specified, the experimental methods adopted are conventional methods, and the materials and reagents adopted are commercially available.

In the following examples and comparative examples, unless otherwise specified, the antioxidant and lubricant are commercially available, and the same antioxidant and lubricant are adopted in parallel experiments.

A melt flow index of PP is tested under the test condition of 230° C. and 2.16 kg in accordance with the test standard ISO 1133-1/2:2012.

A melt flow index of an ethylene-octene random copolymer is tested under the test condition of 190° C. and 2.16 kg in accordance with the test standard ISO 1133-1/2:2012.

The raw materials adopted in examples and comparative examples are as follows:
PP-1: B8101 (copolymerization, melt flow index: 0.5 g/10 min), supplier: SINOPEC Beijing Yanshan Company;
PP-2: K8303 (copolymerization, melt flow index: 3 g/10 min), supplier: SINOPEC Beijing Yanshan Company;
PP-3: EP548R (copolymerization, melt flow index: 30 g/10 min), supplier: CNOOC and Shell Petrochemicals Company Limited (CSPC);
PP-4: R4220 (copolymerization, melt flow index: 0.3 g/10 min), supplier: SINOPEC Beijing Yanshan Company;
PP-grafted maleic anhydride: PC-1, supplier: Foshan Parkson New Material Co., Ltd.;
calcium carbonate: 75T, supplier: Changxing Oumiya Calcium Industry Co., Ltd.;
basic magnesium sulfate whisker: WS-1S2, supplier: Yingkou Kangru Technology Co., Ltd.;
talc powder: AH-51210, 3,000 mesh, supplier: Liaoning Aihai Talc Co. Ltd.;
ethylene-octene random copolymer: 8842 (melt flow index: 1 g/10 min), supplier: Dow Chemical Company of the United States;
ethylene-octene random copolymer: 8200 (melt flow index: 5 g/10 min), supplier: Dow Chemical Company of the United States;
ethylene-octene random copolymer: 8407 (melt flow index: 30 g/10 min), supplier: Dow Chemical Company of the United States;
ethylene-octene random copolymer: 8137 (melt flow index: 13 g/10 min), supplier: Dow Chemical Company of the United States;
thermoplastic elastomer styrene-ethylene-butylene-styrene (SEBS): G1657, supplier: Dow Chemical Company of the United States;
hindered phenol antioxidant: SONOX 1010, commercially available;
phosphite ester antioxidant: SONOX 168, commercially available;
zinc stearate: BS-2818, commercially available; and
inorganic foaming agent: EE25C, supplier: Nippon Fine Chemical.

Poly(1-butene)-grafted sodium maleate (PB-1-g-sodium maleate) was prepared by the following process: Poly(1-butene), sodium maleate, and an antioxidant 168 were thoroughly mixed to produce a mixture. An initiator DTBP, AMS, and 1-octene were dissolved in acetone to produce a mixed solution. The mixed solution was thoroughly mixed with the mixture, and after the acetone was volatilized, melt-extrusion was conducted with a twin-screw extruder at 150° C. to allow a grafting reaction to produce the poly(1-butene)-grafted sodium maleate. The components were used at amounts as follows: 100 parts of the poly(1-butene), 3 parts of the sodium maleate, 0.3 part of the antioxidant, 0.2 part of the DTBP, 3 parts of the AMS, and 1.5 parts of the 1-octene. The poly(1-butene)-grafted sodium maleate was purified as follows: The poly(1-butene)-grafted sodium maleate was dissolved in xylene, precipitation was conducted with acetone to produce a precipitate, and the precipitate was washed and dried to produce a first purification product. The above purification process was repeated twice to produce purified poly(1-butene)-grafted sodium maleate (grafting ratio: 1.2%). The purified poly(1-butene)-grafted sodium maleate was used to prepare a micro-EPP material.

### Examples and Comparative Examples

Components, amounts of the components, and properties for micro-EPP materials in the examples and comparative examples are shown in Tables 1 and 2.

A preparation method for the micro-EPP materials in the examples and comparative examples included the following steps:

The components other than the foaming agent were added to a high-speed mixer and mixed for 3 min to produce a mixed material. A rotational speed of the high-speed mixer was 800 rpm. The mixed material was added to a 75D co-rotating twin-screw extruder and subjected to melt-extrusion granulation, then dried, and cooled to produce a micro-EPP material. Temperatures from a feeding section to a head of the twin-screw extruder were sequentially as follows: 170° C., 200° C., 200° C., 210° C., 210° C., 205° C., 205° C., 205° C., 200° C., and 200° C. The micro-EPP material and 2% of an inorganic foaming agent were thoroughly mixed, added to an extruder, subjected to extrusion foaming, and injection-molded into a 100 mm*100 mm*2 mm square plate for performance testing.

### Performance Testing

The products in the examples and comparative examples each was tested for performance, and a specific test method was as follows:

Appearance: A surface of the 100 mm*100 mm square plate was observed by naked eyes, and a number of orange peel-like sites was counted: excellent: 0 orange peel-like site; acceptable: 1 to 3 orange peel-like sites; and average: 4 to 6 orange peel-like sites.

Compactness and uniformity of foam cells: The 100 mm*100 mm square plate was tested for a foam cell size according to GB/T 12811-1991: grade 1:0 μm to 20 μm; grade 2:21 μm to 40 μm; grade 3:41 μm to 60 μm; grade 4:61 μm to 80 μm; grade 5:81 μm to 100 μm; grade 6:101 μm to 120 μm; grade 7:121 μm to 140 μm; failed foaming; and cell rupturing.

Density: The density was determined according to ISO 1183-1:2019.

Reduced weight proportion: [(density before foaming−density after foaming)/density before foaming]*100%.

Closed-cell ratio: The closed-cell ratio was determined according to GB 10799-2008.

TABLE 1

| | Exam- | Exam- | Exam- | Exam- | Exam- | Exam- | Exam- | Exam- |
|---|---|---|---|---|---|---|---|---|
| | ple 1 | ple 2 | ple 3 | ple 4 | ple 5 | ple 6 | ple 7 | ple 8 |
| Item | | | | | | | | |
| PP-1 B8101 | 62 | 96 | 45 | 53 | / | 62 | 62 | 62 |
| PP-2 K8303 | / | / | / | / | 62 | / | / | / |
| PB-1-g-sodium maleate | 3 | 1 | 5 | 2 | 3 | 3 | 3 | 3 |
| Filler 75T | / | / | / | | / | / | 30 | / |
| Filler WS-1S2 | / | / | / | | / | / | / | 30 |
| Filler AH-51210 | 30 | 3 | 40 | 10 | 30 | 30 | / | / |
| Ethylene-octene random | | | | | | 5 | | |
| copolymer 8137 | | | | | | | | |
| Ethylene-octene random | 5 | 2 | 10 | 7 | 5 | / | 5 | 5 |
| copolymer 8200 | | | | | | | | |
| Antioxidant SONOX | 0.15 | 0.05 | 0.2 | 0.15 | 0.15 | 0.15 | 0.15 | 0.15 |
| 1010 | | | | | | | | |
| Antioxidant SONOX 168 | 0.15 | 0.05 | 0.2 | 0.15 | 0.15 | 0.15 | 0.15 | 0.15 |
| Lubricant BS-2818 | 0.25 | 0.1 | 0.4 | 0.25 | 0.25 | 0.25 | 0.25 | 0.25 |
| Foaming agent EE25C | 2 | 1 | 3 | 2 | 2 | 2 | 2 | 2 |
| Test item | | | | | | | | |
| Density before | 1.13 | 0.921 | 1.22 | 0.966 | 1.13 | 1.13 | 1.13 | 1.13 |
| foaming/(g/cm³) | | | | | | | | |
| Density after | 0.844 | 0.712 | 0.928 | 0.661 | 0.747 | 0.831 | 0.843 | 0.823 |
| foaming/(g/cm³) | | | | | | | | |
| Reduced weight | 25.3 | 22.7 | 23.9 | 31.6 | 25.2 | 26.5 | 25.4 | 27.2 |
| proportion/% | | | | | | | | |
| Closed-cell ratio/% | 93.5 | 92.5 | 92.7 | 94.3 | 93.1 | 92.3 | 94.3 | 93.4 |
| Appearance | Excellent | Excellent | Excellent | Excellent | Excellent | Excellent | Excellent | Excellent |
| Compactness and | Grade 1 | Grade 1 | Grade 1 | Grade 1 | Grade 1 | Grade 1 | Grade 1 | Grade 1 |
| uniformity of foam cells | | | | | | | | |

TABLE 2

| | Compar- | Compar- | Compar- | Compar- | Compar- | Compar- | Compar- | Compar- | Compar- | Compar- |
|---|---|---|---|---|---|---|---|---|---|---|
| | ative | ative | ative | ative | ative | ative | ative | ative | ative | ative |
| | Exam- | Exam- | Exam- | Exam- | Exam- | Exam- | Exam- | Exam- | Exam- | Exam- |
| | ple 1 | ple 2 | ple 3 | ple 4 | ple 5 | ple 6 | ple 7 | ple 8 | ple 9 | ple 10 |
| Item | | | | | | | | | | |
| PP-1 | 62 | / | 62 | 62 | 62 | 62 | 62 | 62 | 62 | |
| B8101 | | | | | | | | | | |
| PP-3 E | / | 62 | / | / | / | / | / | / | | |
| P548R | | | | | | | | | | |
| PP-4 | | | | | | | | | | 62 |
| R4220 | | | | | | | | | | |
| PB-1-g- | / | 3 | / | 3 | 3 | 3 | 0.5 | 3 | 8.5 | 3 |
| sodium | | | | | | | | | | |
| maleate | | | | | | | | | | |
| PC-1 | / | / | 3 | / | / | / | / | / | | |
| Filler | 30 | 30 | 30 | 30 | 30 | 30 | 30 | 30 | 30 | 30 |
| AH-51210 | | | | | | | | | | |
| Ethylene- | 5 | 5 | 5 | / | / | / | 5 | 1 | 5 | 5 |
| octene | | | | | | | | | | |
| random | | | | | | | | | | |
| copolymer | | | | | | | | | | |
| 8200 | | | | | | | | | | |
| Ethylene- | / | / | / | 5 | / | / | / | / | | |
| octene | | | | | | | | | | |
| random | | | | | | | | | | |
| copolymer | | | | | | | | | | |
| 8842 | | | | | | | | | | |
| Ethylene- | / | / | / | / | 5 | / | / | / | | |
| octene | | | | | | | | | | |
| random | | | | | | | | | | |
| copolymer | | | | | | | | | | |
| 8407 | | | | | | | | | | |
| SEBS | / | / | / | / | / | 5 | / | / | | |
| G1657 | | | | | | | | | | |
| Antioxidant | 0.15 | 0.15 | 0.15 | 0.15 | 0.15 | 0.15 | 0.15 | 0.15 | 0.15 | 0.15 |
| SONOX | | | | | | | | | | |
| 1010 | | | | | | | | | | |
| Antioxidant | 0.15 | 0.15 | 0.15 | 0.15 | 0.15 | 0.15 | 0.15 | 0.15 | 0.15 | 0.15 |
| SONOX | | | | | | | | | | |
| 168 | | | | | | | | | | |
| Lubricant | 0.25 | 0.25 | 0.25 | 0.25 | 0.25 | 0.25 | 0.25 | 0.25 | 0.25 | 0.25 |
| BS-2818 | | | | | | | | | | |
| Foaming | 2 | 2 | 2 | 2 | 2 | 2 | 2 | 2 | 2 | 2 |
| agent | | | | | | | | | | |
| EE25C | | | | | | | | | | |
| Test item | | | | | | | | | | |
| Density | 1.13 | 1.13 | 1.13 | 1.13 | 1.13 | 1.13 | 1.13 | 1.13 | 1.13 | 1.13 |
| before | | | | | | | | | | |
| foaming/ | | | | | | | | | | |
| (g/cm³) | | | | | | | | | | |
| Density | 0.987 | 1.006 | 0.975 | 0.933 | 0.945 | 0.982 | 0.992 | 0.981 | 1.001 | 1.087 |
| after | | | | | | | | | | |
| foaming/ | | | | | | | | | | |
| (g/cm³) | | | | | | | | | | |
| Reduced | 12.7 | 11 | 13.7 | 17.4 | 16.4 | 13.1 | 12.2 | 13.2 | 11.4 | 9.6 |
| weight | | | | | | | | | | |
| proportion/ | | | | | | | | | | |
| % | | | | | | | | | | |
| Closed-cell | 83.6 | 46.4 | 65.7 | 88.4 | 76.7 | 56.7 | 74.3 | 66.4 | 56.8 | 34.5 |
| ratio/% | | | | | | | | | | |
| Appearance | Average | Acceptable | Average | Acceptable | Acceptable | Average | Acceptable | Acceptable | Average | Average |
| Compactness | Grade 4 | Grade 4 | Grade 3 | Grade 7 | Grade 4 | Grade 7 | Grade 4 | Grade 7 | Grade 4 | Grade 7 |
| and | | | | | | | | | | |
| uniformity | | | | | | | | | | |
| of foam | | | | | | | | | | |
| cells | | | | | | | | | | |

Results: In the micro-EPP material in Comparative Example 1, the poly(1-butene)-grafted sodium maleate is not added. Comparative Example 1 has a significantly-smaller reduced weight proportion and closed-cell ratio than Example 1, and exhibits poor compactness and uniformity of foam cells and an average appearance. For the micro-EPP material in Comparative Example 2, PP with a melt flow index of 30 g/10 min is adopted for extrusion foaming. Comparative Example 2 has a much smaller reduced weight proportion and closed-cell ratio than Example 1, and exhibits poor compactness and uniformity of foam cells and an acceptable appearance. In the micro-EPP material in Comparative Example 3, the PP-grafted maleic anhydride is used instead of the poly(1-butene)-grafted sodium maleate. Comparative Example 3 has a significantly-inferior reduced weight proportion and closed-cell ratio to Example 1, and exhibits poor compactness and uniformity of foam cells and an average appearance. Ethylene-butene random copolymers with melt flow indexes of 1 g/10 min and 30 g/10 min are adopted in Comparative Examples 4 and 5, respectively. Comparative Examples 4 and 5 both possess a smaller reduced weight proportion and closed-cell ratio than Example 1, and have acceptable appearances, but both exhibit poor compactness and uniformity of foam cells. In Comparative Example 6, SEBS is used instead of the ethylene-octene random copolymer. Comparative Example 6 undergoes shrinkage of foam cells, and has poor compactness and uniformity of foam cells. An amount of the PB-1-g-sodium maleate in Comparative Example 7 is too small. Comparative Example 7 has a smaller reduced weight proportion and closed-cell ratio than Example 1, and exhibits an acceptable appearance and poor compactness and uniformity of foam cells. An amount of the ethylene-octene random copolymer is too small in Comparative Example 8. Correspondingly, Comparative Example 8 has a smaller reduced weight proportion and closed-cell ratio than Example 1, and exhibits an acceptable appearance and poor compactness and uniformity of foam cells. An amount of the poly(1-butene)-grafted sodium maleate is too large in Comparative Example 8. Accordingly, Comparative Example 8 has a significantly-smaller reduced weight proportion and closed-cell ratio than Example 1, and exhibits poor compactness and uniformity of foam cells and an average appearance. An amount of the poly(1-butene)-grafted sodium maleate is too large in Comparative Example 9, resulting in poor compactness and uniformity of foam cells and an average appearance. In Comparative Example 10, PP with a melt flow index of 0.3 g/10 min is adopted for extrusion foaming, accordingly, the forming is difficult, and a resulting product has a small reduced weight proportion and a low closed-cell ratio.

Finally, it should be noted that the above examples are provided merely to describe the technical solutions of the present disclosure, rather than to limit the protection scope of the present disclosure. Although the present disclosure is described in detail with reference to preferred examples, a person of ordinary skill in the art should understand that modifications or equivalent replacements may be made to the technical solutions of the present disclosure without departing from the spirit and scope of the technical solutions of the present disclosure.

1. A microexpanded polypropylene (micro-EPP) material, comprising the following components in parts by weight: 45 parts to 96 parts of polypropylene (PP), 1 part to 5 parts of poly(1-butene)-grafted sodium maleate, 2 parts to 10 parts of an ethylene-octene random copolymer, 3 parts to 40 parts of a filler, 0.1 part to 0.4 part of a lubricant, and 0.1 part to 0.4 part of an antioxidant,
wherein a melt flow index of the PP is 0.5 to 3 g/10 min; and
a melt flow index of the ethylene-octene random copolymer is 5 to 13 g/10 min.

2. The micro-EPP material according to claim 1, comprising the following components in parts by weight: 53 parts to 62 parts of the PP, 2 parts to 3 parts of the poly(1-butene)-grafted sodium maleate, 5 parts to 7 parts of the ethylene-octene random copolymer, 10 parts to 30 parts of the filler, 0.1 part to 0.4 part of the lubricant, and 0.1 part to 0.4 part of the antioxidant.

3. The micro-EPP material according to claim 1, wherein the filler is at least one selected from the group consisting of a talc powder, calcium carbonate, and a basic magnesium sulfate whisker.

4. The micro-EPP material according to claim 1, wherein the lubricant is a stearate salt.

5. The micro-EPP material according to claim 1, wherein the antioxidant is a hindered phenol and/or a phosphite ester.

6. A preparation method of the micro-EPP material according to claim 1, comprising the following steps: mixing the components thoroughly, and conducting melt-extrusion granulation; and adding a foaming agent, and conducting extrusion foaming to produce the micro-EPP material.

7. The preparation method of the micro-EPP material according to claim 6, wherein the foaming agent is added at an amount of 1 wt % to 3 wt % of the micro-EPP material.

8. A compression-resistant, cushioning, and heat-insulating material, wherein a raw material for preparing the compression-resistant, cushioning, and heat-insulating material comprises the micro-EPP material according to claim 1.

9. The micro-EPP material according to claim 2, wherein the filler is at least one selected from the group consisting of a talc powder, calcium carbonate, and a basic magnesium sulfate whisker.

10. The micro-EPP material according to claim 2, wherein the lubricant is a stearate salt.

11. The micro-EPP material according to claim 2, wherein the antioxidant is a hindered phenol and/or a phosphite ester.

12. The preparation method of the micro-EPP material according to claim 6, wherein the micro-EPP material comprises the following components in parts by weight: 53 parts to 62 parts of the PP, 2 parts to 3 parts of the poly(1-butene)-grafted sodium maleate, 5 parts to 7 parts of the ethylene-octene random copolymer, 10 parts to 30 parts of the filler, 0.1 part to 0.4 part of the lubricant, and 0.1 part to 0.4 part of the antioxidant.

13. The preparation method of the micro-EPP material according to claim 12, wherein the foaming agent is added at an amount of 1 wt % to 3 wt % of the micro-EPP material.

14. The preparation method of the micro-EPP material according to claim 6, wherein the filler is at least one selected from the group consisting of a talc powder, calcium carbonate, and a basic magnesium sulfate whisker.

15. The preparation method of the micro-EPP material according to claim 6, wherein the lubricant is a stearate salt.

16. The preparation method of the micro-EPP material according to claim 6, wherein the antioxidant is a hindered phenol and/or a phosphite ester.

17. The compression-resistant, cushioning, and heat-insulating material according to claim 8, wherein the micro-EPP material comprises the following components in parts by weight: 53 parts to 62 parts of the PP, 2 parts to 3 parts of the poly(1-butene)-grafted sodium maleate, 5 parts to 7 parts of the ethylene-octene random copolymer, 10 parts to 30 parts of the filler, 0.1 part to 0.4 part of the lubricant, and 0.1 part to 0.4 part of the antioxidant.

18. The compression-resistant, cushioning, and heat-insulating material according to claim 8, wherein the filler is at least one selected from the group consisting of a talc powder, calcium carbonate, and a basic magnesium sulfate whisker.

19. The compression-resistant, cushioning, and heat-insulating material according to claim 8, wherein the lubricant is a stearate salt.

20. The compression-resistant, cushioning, and heat-insulating material according to claim 8, wherein the antioxidant is a hindered phenol and/or a phosphite ester.
